(19) United States
(12) Patent Application Publication
(10) Pub. No.: US 2003/0223043 A1
(43) Pub. Date: Dec. 4, 2003

(54) High resolution 3 dimensional image generator

(76) Inventor: Kazutora Yoshino, Madison, WI (US)

Correspondence Address: Yoshino, Kazutora, 226 N. Hillside Tr., MADISON, WI, 53705, US

(21) Appl. No.: 10/252,882

(22) Filed: Sep. 23, 2002

Related U.S. Application Data
(63) Continuation of application No. 10/161,181, filed on Jun. 3, 2002, now Pat. No. 6,620,825.

(51) Int. Cl. G03B 21/00

(52) U.S. Cl. 353/10

(57) ABSTRACT

By this invention, multi-users can view the 3 dimensional objects or images in real time (run time) with high resolutions without special glasses in the space or in the air due to the fast movement of voxels projected by voxel projector means.

### FEDERALLY SPONSORED RESEARCH

Not Applicable

### SEQUENCE LISTING OR PROGRAM

Not Applicable

### BACKGROUND OF INVENTION

1. Field of Invention

This is a continuation of the patent application of “Intelligent System and 3D virtual object generator” Ser. No. 10/161,180 and “3 dimensional image projector and holodeck” This invention relates to the image display devices, specifically to 3DTV, hologram, stereo display device that are used for displaying the 3 dimensional object or images and 3D scanners.

2. Description of Prior Art

It is difficult to generate 3D images using “point scanning or voxel scanning” with high resolution with long depth. This is because the scanner available was slow and as the result 3D images become very rough resolution. U.S. Pat. Nos. 5,954,414, 1999, and 6302,542, 2001, by Tsao reveal this point and their device uses simple 2D image projector to create 3D images assuming point scanning is too slow. But these methods are not good enough for the practical usage of 3D images such as engineering applications. Also, they don't show practical way of making 3D images. And they don't show the practical way of how to make the high transverse resolution with high depth resolution for 3D images. Also, in their method, since they are simply shaking the screen, 3D images tend to be rough in quality.

U.S. patent application No. 20,020,130,820 by Sullivan, Alan and U.S. patent application Ser. No. 60/004111 FIG. 10, 1995 by Kazutora Yoshino reveals that the device can make 3D image out of multiple 2D images projected into the multi-layers of the liquid crystal. The proper voltage is applied to each layer in proper timing to create the shift on a non-transparent layer between transparent layers. Images are projected to the non-transparent layer using high-resolution projector But this device has problems in the way that too much light is reflected on each layers and therefore the images in the deep portion get fuzzy and unclear. Also, it is a very expensive device. Currently DMA sells their product around $150,000.

In U.S. Pat. No. 5,956,172 (1999) and U.S. Pat. No. 5,684,621 (1997) by Elizabeth Anne Downing, it shows the way to display the 3D image in a crystal. But user still cannot touch to the 3D image. Also, coupling (intersecting) two light beams is difficult and expensive in many cases since it need to use more direction specifying device such as galvanometers. Also, it is difficult and expensive to create big crystal used in these methods. Also, these methods do not show how to make full color 3D image. It may show only red, green and green color.

In U.S. Pat. No. 3,647,284, (1970) Virgil B Ethlgs, et al. show the method of showing 3 dimensional images made by the light that was originally scattered by an object. This device put two dish means facing each other. The top dish means has a hole in the middle and 3 dimensional image shows up over this hole when user put the object at the bottom of the bottom dish means. But this device by itself would be unsuitable to show the real time (run time) 3 dimensional image.

Object and Advantages

This invention has advantages relative to prior art in

1) It gives very high resolution 3D images,

2) It gives clear 3D images in the space even at the deep portions of image,

3) 3D images become very well controlled in depth resolution,

4) More silent in operation,

5) The cost efficient,

6) Energy efficient,

7) It looks like the 3D images are in the air.

### SUMMARY

In spite of arguments of prior art, the recent development of high definition scanner led the development of Grating Light Valve technology that let voxel move so fast that the 3D images generated by voxels on a moving panel can have high resolution and high depth resolution.

The idea how Grating Light Valve (GLV) works is the following. It has moving ribbons and fixed ribbons, and they are alternatively arranged. Depending on the voltage applied to the GLV, moving ribbons change height accordingly. Therefore, it becomes a controlled grating. As it creates the diffraction grating that can change the diffraction angle of light beam depending on the voltage applied. GLV elements can be operated in either a digital mode or continuously variable analog mode.

In order to generate the high resolution 3D images, our invention makes a screen move very fast (about 20 time/sec to 70 time/sec) having a projection from High definition voxel projector such as a voxel projector having frame rate of 20 kHz with transversal resolution of 2048*2048 pixels by SILICON LIGHT MACHINES. In this example, 3D image can have 2048*2048*1000 resolution if 20 times/sec of screen movement such as oscillation is made.

Also, our invention includes the position monitoring system linking to the motion generating system and image projecting system to create the high quality 3D image generation.

As an alternative embodiment, the high definition voxel scanner can be used to create the 3D images in a crystal or layers of crystal. In this case the infrared rays are usually used to intersect in the voxel, where visible photons emit, and to scan the voxel very fast to generate the 3D images.

### DRAWINGS

Drawing Figures

FIG. 1 shows the example diagram of a 3 dimensional image generator with linear motion

FIG. 2 shows the alternative example diagram of a 3 dimensional image generator with rotating motion

FIG. 3 shows the example diagram of a 3 dimensional image generator with more detailed components of voxel projector.

FIG. 4 shows the example diagram of a 3 dimensional image generator with multiple support of screen.

FIG. 5(a1) shows the example diagram of a voxel projector and the principle.

FIG. 5(a2) shows the example diagram of a voxel projector and focus adjusting means to create the proper image projection.

FIG. 5(a3) shows the example diagram of 3 dimensional image generator with a voxel projector, focus adjusting means, the screen means, and the moving screen means.

FIG. 6 shows the example diagram of grating light valve (GLV).

FIG. 7 shows the alternative example diagram of 3 dimensional image generator with photon emitting material means.

FIG. 8(a1) shows the example diagram of 3 dimensional image generator with optional image lifting means

FIG. 8(a2) shows the alternative example diagram of 3 dimensional image generator with optional image lifting means

FIG. 9 shows the example diagram of 3 dimensional image generator with image lifting means and input device means

FIG. 10 the example diagram of controller of 3 dimensional image generator.

FIG. 11(a1) shows the example diagram of table application with 3 dimensional image generator.

FIG. 12(a2) shows the alternative example diagram of table application with 3 dimensional image generator.

### REFERENCE NUMERALS IN DRAWINGS

{1} 3D image generator

{2} Screen means

{3} Moving screen means

{4} Voxel projector means

{5} Focus Adjustable means

{7} 3D image

{8} Scanner means

{9} Lens means

{10} Liner GLV means

{12} Laser means

{20} Moving Ribbon means

{21} Fixed Ribbon means

{22} Air Gap

{23} Common Electrode

{30} Photon emitting material means

{40} Image lifting means

{42} Magnifier means

{50} Input device means

{70} Sensor means

{71} Motor means

{72} GLV means

{73} Scanner means

{74} Laser means

{80} Controller means

{81} Sensor driver

{82} Motor driver

{83} Voxel driver

{84} GLV driver

{85} Scanner driver

{86} Laser driver

{87} Master driver

{88} Image data driver

{90} Computer means

{91} video card means

{92} CPU means

{93} other components

{94} 3D image data

{100} Table application with 3D image generator

{101} Magnifier means

{102} support means

{105} base means

### DETAILED DESCRIPTION

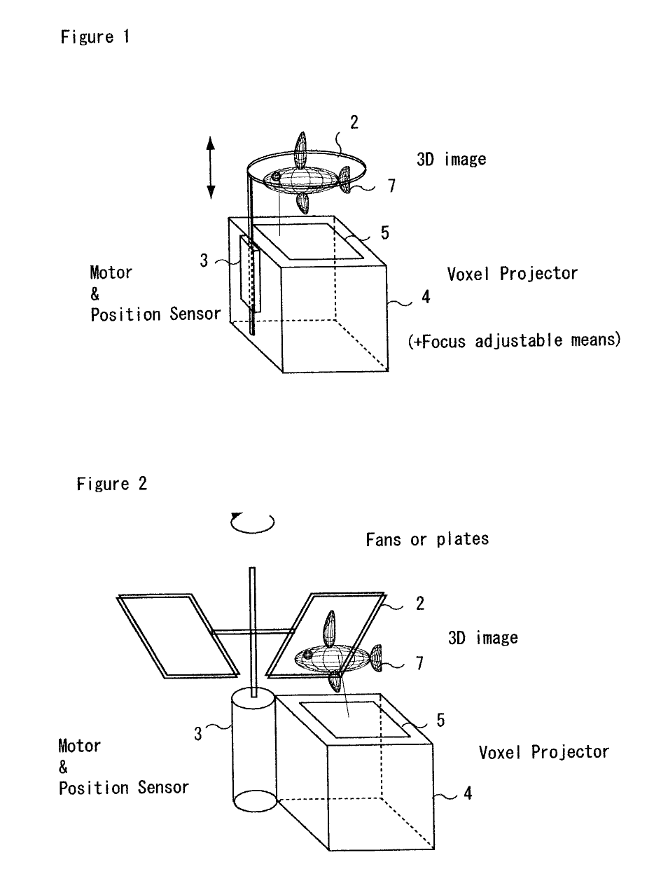

Description—FIGS. 1, 2—Preferred Embodiment

A preferred embodiment of the 3D image generator is illustrated in FIG. 1, FIG. 2.

FIG. 1 shows the example diagram of a 3 dimensional image generator with linear motion. {1} 3D image generator is composed of screen means {2}, moving screen means {3}, voxel projector means {4}, and focus adjustable means {5}. Voxels corresponding to transverse location are projected to a screen {2} moving reciprocally or in the position corresponding to the proper depth so that the resultant images become 3D images.

FIG. 2 shows the alternative example diagram of a 3 dimensional image generator with rotating motion. It has rotating screen {2} such as fan and plates with voxel projection.

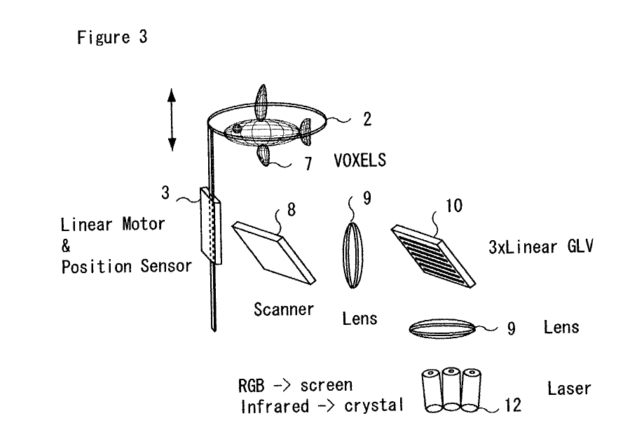

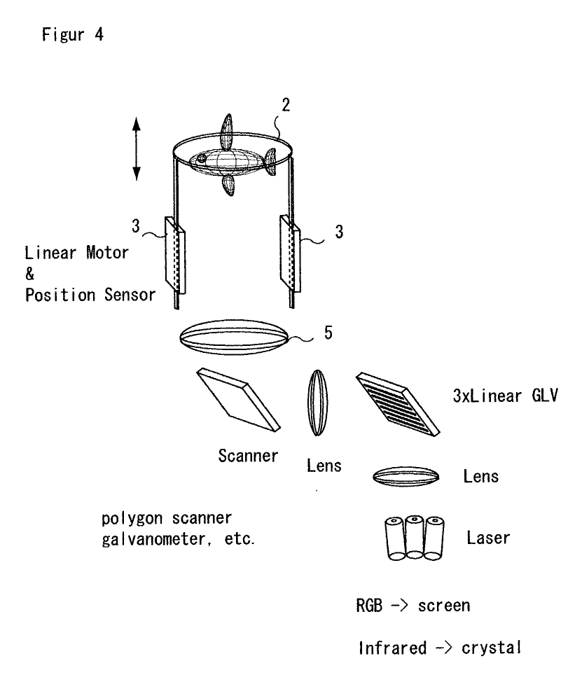

FIGS. 3, 4, 5, 6, 8, 9, 10, 11—Additional Embodiments

FIG. 3 shows the example diagram of a 3 dimensional image generator with more detailed components of voxel projector. The moving screen means has a linear motor and its sensor in this example. And the voxel projector means has scanner means {8}, Lens means {9} Linear GLV means {10}, and Laser means {12}. If the screen is a simple white or half transparent panel, etc, lasers can be red, green, blue laser. If the panel is a crystal that emit the visible light, laser can be infrared laser. For example, color Laser beam is emitted to go through Lens means {9} to hit the Linear GLV means where the beams are deflected in angles depending on the voltage applied to the GLV. The beam go through the next Lens means {9} and it would be reflected by scanner means {8}. This beam can be re-adjusted by the focus adjusting means {5}. The beam hit the screen to create voxel. The transverse-motion due to GLV and Scanner and depth-moion due to the screen movement enable the voxel to move the 3 dimensional space. Rapid movement of voxel/voxels generates 3d images.

FIG. 4 shows the example diagram of a 3 dimensional image generator with multiple support of screen. Basically this is almost the same as FIG. 3 except this example has multiple support of the moving screen means {3} in order to increase the speed and support of the screen.

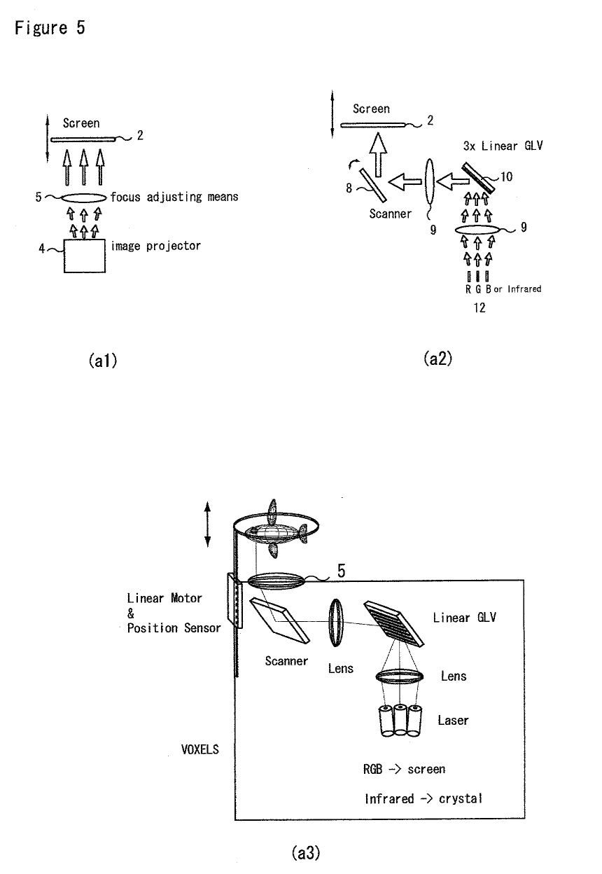

FIG. 5(a1) shows the example diagram of a voxel projector and the principle. Red, Green, Blue Laser beam are emitted to go through Lens means {9} to hit the proper locations with proper angles in the Linear GLV means where the beams are deflected in the angles depending on the voltage applied to the GLV. The beam go through the next Lens means {9} and it would be reflected in the proper angles depending selected by scanner means { 8}. The beam hit the screen to create voxel. The transverse-motion due to GLV and Scanner and depth-moion due to the screen movement enable the voxel to move the 3 dimensional space. Rapid movement of voxel/voxels generates 3d images.

FIG. 5(a2) shows the example diagram of a voxel projector and focus adjusting means to create the proper image projection. This example has the focus adjusting means {5} as a part of voxel projector to image projector to create the parallel beams to for the screen so that the image will be clear on the screen.

FIG. 5(a3) shows the example diagram of 3 dimensional image generator with a voxel projector with focus adjusting means, the screen means, and the moving screen means.

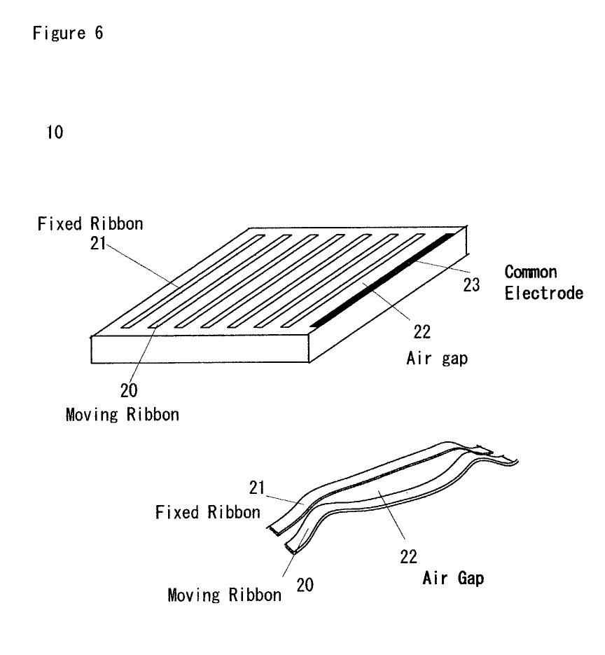

FIG. 6 shows the example diagram of grating light valve (GLV) {10}. Moving ribbon means {20} changes the air gap distance relative to the Fixed ribbon means when proper voltages are applied to GLV. This create the variable grating effect on light beams therefore, GLV can choose the diffraction angles of light beams.

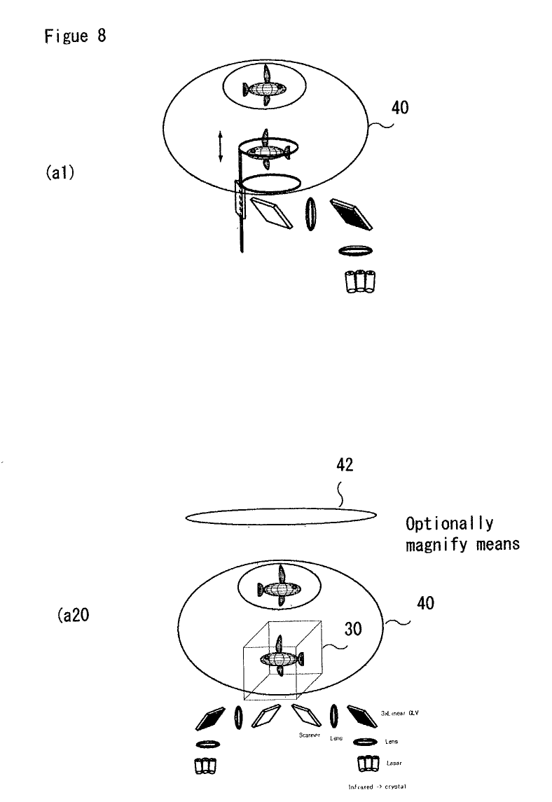

FIG. 8(a1) shows the example diagram of 3 dimensional image generator with optional image lifting means {40}. Image lifting means can be conventional two parabola like image lifting device or combinations of lenses.

FIG. 8(a2) shows the alternative example diagram of 3 dimensional image generator with optional image lifting means. This one has photon emitting means {30} such as a crystal in the image lifting means {40}. These also can have magnifier means {42} to magnify the 3D images.

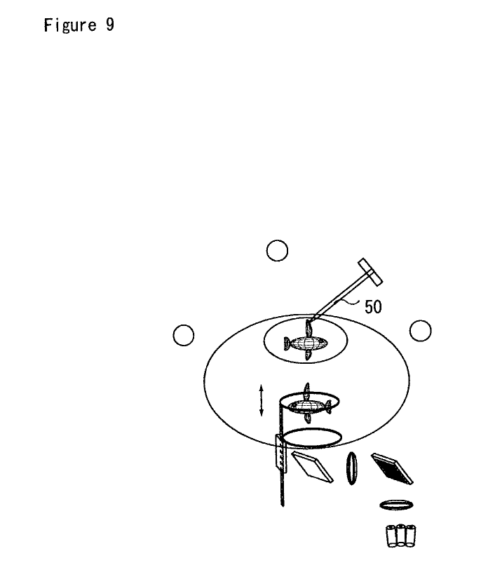

FIG. 9 shows the example diagram of 3 dimensional image generator with image lifting means and input device means {50}. The example of input device here is the wand that can find the positions and angles (6 degrees of freedom) of its own using the electro-magnetic wave. The input devices can be 3D mouse, haptic hand (MIT), haptic wands, etc.

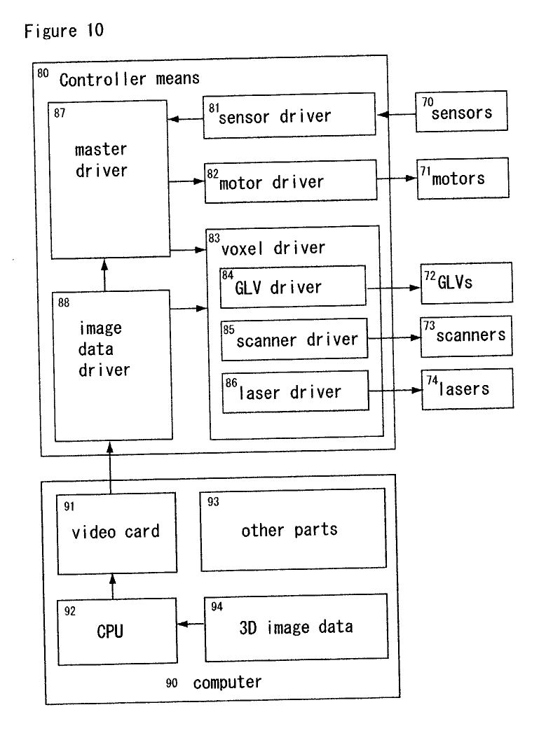

FIG. 10 the example diagram of controller of 3 dimensional image generator. In this example, CPU {92} send 3D image data to image data driver {88} through video card {91}. Master driver {87} read the position of the screen from sensors {70} through sensor driver {81}. If it need to move to the next position of voxel, it send the signals to move the motor {71} through motor driver {82}, and the transverse voxel position and color through the voxel driver {83}.

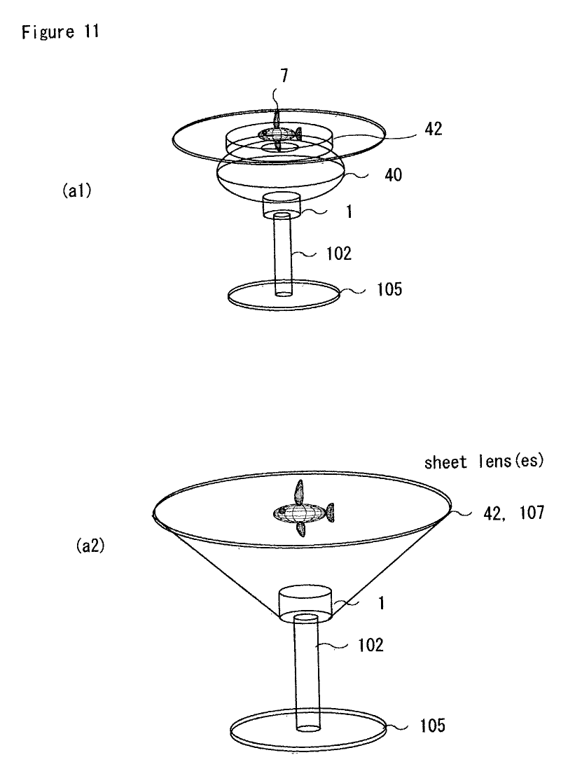

FIG. 11(a1) shows the example diagram of table application with 3 dimensional image generator. This example is for fitting the size and shape of the 3D image generator to a table so that users can have efficient space usage.

FIG. 11(a2) shows the alternative example diagram of table application with 3 dimensional image generator.

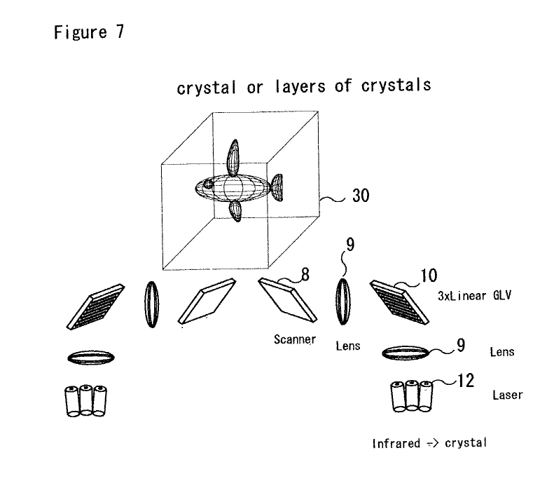

FIG. 7, —Alternative and Other Embodiment—and Examples

FIG. 7 shows the alternative example diagram of 3 dimensional image generator with photon emitting material means. In this example, two voxel projectors are used to create the intersection in photon emitting means {30} such as crystal. The coupling effect of infrared light at the intersection creates the light emission at the voxel in the crystal. The scanning of voxel creates the 3D image.

Advantages

As mentioned, this invention has advantages relative to prior art in

1) It gives very high resolution 3D images,

2) It gives clear 3D images in the space even at the deep portions of image,

3) 3D images become very well controlled in depth resolution,

4) More silent in operation

5) The cost efficient.

6) Energy efficient

7) It looks like the 3D images are in the air

Operation—FIG 1, FIG. 2, FIG. 7, FIG. 8

One example of operation is that user can put the 3 dimensional image generator means in front of the objects, creatures such as user himself/herself and record the 3D video image. Then the recorded image can travel though network such as Internet to another 3D image generator means which displays the 3D image recorded either immediately or after some time. User can use this 3D image generator as data transform methods.

Another example of usage is that it can monitor the internal organs, infant in a mother of humans. The 3D data acquired from ultrasound scanner, CT scanner, X-rays can be sent to the 3D image generated by the 3D image generator.

Another example of usage is that engineer people can design objects interfacing directly with 3D image by their hand, input device, etc.

Another example of usage is that bioinformatists can design their proteins, drugs interfacing directly with 3D proteins/drug image by their hand, input device, etc.

Another example of usage is that people can put this device under a table with hole so that displayed 3D image shows up in the middle of table and can use as a general display.

Another way of using this device is that users teach their commands interacting with the invention by language or by visual language such as finger or hand movement. The device talks back to the users if its action is correct or how well done. Users gives response, and the invention learns the commands depending on the response. The invention shows what the invention is thinking by showing to the 3 dimensional virtual images to users. The invention can learn new materials by itself or by users visually looking at new materials or by listening sound, the language and music or by connecting to the information source such as electric dictionary or Internet.

Conclusion, Ramifications, and Scope

By this invention, multi-users can view the 3 dimensional objects or images in real time (run time) with high transverse resolution and depth resolution without special glasses in the air.

I claim

1. The three dimensional image generator means that creates three dimensional images comprising the devices selected from the group consisting of
1) screen means
2) moving a screen means
3) voxel projector means.
4) optionally, image lifting means
5) optionally, input device means
6) optionally, computer means
7) controller means
8) support means

2. The invention of claim of [1], wherein said screen means is composed of screens from the group consisting of
plastic screen, paper screen, glass screen, film, organic material screen, inorganic material screen, crystal, plasma gas, gas with container, liquid with container, solid material, superconductors.

3. The invention of claim of [1], wherein said moving screen means is composed of devices from the group consisting of
1) generating motion means
2) sensor means

4. The invention of claim of [3], wherein said generating motion means is composed of devices from the group consisting of
1) motor means comprising
linear motors, stepping motors, direct current motors, solenoid, air pump
2) screen support means comprising
rod, pole, column, or pipe.
3) gear means comprising
gears, oval gears, linear gears.

5. The invention of claim of [3], wherein said sensor means is composed of feed back information devices from the group consisting of position detecting system, motion detecting system, switches, encoders, beam reflecting sensing devices, infrared position detecting system, distance reading device, ultrasound emitters and sensors.

6. The invention of claim of [1], wherein said moving screen means is composed of devices from the group consisting of
1) system to generate and monitor reciprocal motions
2) system to generate and monitor linear screen motions
3) system to generate and monitor the screen motions with specified locations
4) system to generate and monitor rotating screen motions.

7. The invention of claim of [1], wherein said voxel projector means is composed of the devices from the group consisting of
1) light path changing means
2) lens means
3) light source means
4) adjusting focus means

8. The invention of claim of [7], wherein said light path changing means is composed of the devices from the group consisting of
1) grating light valve system
2) acousto-optic deflectors system
3) electro-optic deflectors system
4) galvanometers system

9. The invention of claim of [7], wherein said light source means is composed of the devices from the group consisting of
lasers, light bulbs, device to emit light

10. The invention of claim of [7], wherein said lens means is composed of the devices from the group consisting of
lens, sheet lens, acoust-optic lens, electro-optic lens, pin hole lens, focus changeable lenses.

11. The invention of claim of [1], wherein said image lifting means is composed of the devices from the group consisting of
1) two parabola like inside reflective dishes with holes combinations of said lens means such as lens, sheet lens, acoust-optic lens, electro-optic lens, pin hole lens, focus changeable lenses.
2) image magnifier means comprising lens, sheet lens, acoust-optic lens, electro-optic lens, pin hole lens.

12. The invention of claim of [1], wherein said input device means is composed of the devices from the group consisting of
1) electromagnetic input device
2) ultrasound input device
3) force ball
4) joystick
5) mouse
6) wand
7) haptics device means such as force feed back haptic hand, force feed back haptic wand
8) input devices that can receive the attributes of users actions such as positions, angles, motions, shape, color.

13. The invention of claim of [1], wherein said input computer means is composed of the devices from the group consisting of
1) super computer
2) personal computer
3) small integrated computer.

14. The invention of claim of [1], wherein said controller means is composed of the devices from the group consisting of
1) master driver
2) image data driver
3) sensor driver
4) said moving a screen means driver
5) voxel driver comprising grating light valve driver, scanner driver, and laser driver
6) optionally, input device driver

15. The invention of claim of [1], wherein said support means input device means is composed of the devices from the group consisting of
shaped materials to support said screen means, said moving a screen means, said voxel projector means, image lifting means, input device means, computer means, and controller means.

16. The table means with three dimensional image generator means that creates three dimensional images

17. The invention of claim of [16], wherein said table means is composed of the devices from the group consisting of
1) surface
2) a leg or legs
3) base

18. The entertainment center means with three dimensional image generator means that creates three dimensional images.

19. The invention of claim of [18], wherein said entertainment center means is composed of the devices from the group consisting of
1) image lifting means
2) three dimensional image generator

20. The invention of claim of [19], wherein said image lifting means is composed of the devices from the group consisting of
1) hemisphere-like image lifting device
2) curved surfaced reflectors
3) flat surfaced reflectors
4) lens means such as lens, sheet lens, acoust-optic lens, electro-optic lens, pin hole lens, focus changeable lenses.
5) devices that lift three dimensional images into air or space.
